(19) United States
(12) Patent Application Publication
(10) Pub. No.: US 2022/0285921 A1
(43) Pub. Date: Sep. 8, 2022

(54) SYSTEM OF CONTROLLING IGNITION COIL AND METHOD THEREOF

(71) Applicants: HYUNDAI MOTOR COMPANY, Seoul (KR); KIA CORPORATION, Seoul (KR)

(72) Inventors: Kiseon Sim, Suwon-si (KR); Dongwon Jung, Gwacheon-si (KR); Won Gyu Kim, Seoul (KR); Jin Oh Song, Hwaseong-si (KR); Soo Hyung Woo, Seoul (KR)

(21) Appl. No.: 17/519,189

(22) Filed: Nov. 4, 2021

(30) Foreign Application Priority Data
Mar. 4, 2021 (KR) 10-2021-0028700

(51) Int. Cl. H01T 15/00

(52) U.S. Cl. CPC H01T 15/00

(57) ABSTRACT

An ignition coil control system according to an exemplary embodiment of the present disclosure may include a first ignition coil, a second ignition coil, a spark plug generating spark discharge by a discharge current generated in the first ignition coil and the second ignition coil, and an ignition controller that controls spark discharge of the spark plug by adjusting an amount and duration of the discharge current of the first ignition coil and the second ignition coil, and changing a sequence of charging and discharging of the first ignition coil and the second ignition coil based on a pulse signal transmitted from an engine control unit (ECU).

### CROSS REFERENCE TO RELATED APPLICATIONS

This application claims priority to and the benefit of Korean Patent Application No. 10-2021-0028700 filed in the Korean Intellectual Property Office on Mar. 4, 2021, the entire contents of which are incorporated herein by reference.

### BACKGROUND

### (a) Field

The present disclosure relates to a system of controlling an ignition coil control system and a method. More particularly, the present disclosure relates to an ignition coil control system and a method capable of improving a durability of an ignition coil that applies current to a spark.

### (b) Description of the Related Art

In gasoline vehicles, a mixture of air and fuel is ignited by a spark generated by a spark plug to be combusted. That is, the air-fuel mixture injected into a combustion chamber during a compression stroke is ignited by a discharge phenomenon of the spark plug, and thus energy required for vehicle's driving is generated while undergoing a high temperature and high pressure expansion process.

The spark plug provided in the gasoline vehicle serves to ignite a compressed air-fuel mixture by spark discharge caused by a high voltage current generated by an ignition coil.

In a conventional spark plug, current generated from the ignition coil is applied to a pair of electrodes, causing spark discharge. However, due to repeated usage of the ignition coil, the temperature of the ignition coil is excessively increased, which causes damage to the ignition coil.

The above information disclosed in this Background section is only for enhancement of understanding of the background of the disclosure, and therefore it may contain information that does not form the prior art that is already known in this country to a person of ordinary skill in the art.

### SUMMARY

The present disclosure has been made in an effort to provide an ignition coil control system and method that may improve the durability of an ignition coil applying current to a spark plug.

An ignition coil control system according to an exemplary embodiment of the present disclosure may include a first ignition coil, a second ignition coil, a spark plug generating spark discharge by a discharge current generated in the first ignition coil and the second ignition coil, and an ignition controller that controls spark discharge of the spark plug by adjusting an amount and duration of the discharge current of the first ignition coil and the second ignition coil, and changing a sequence of charging and discharging of the first ignition coil and the second ignition coil based on a pulse signal transmitted from an engine control unit (ECU).

The ignition controller may change a sequence of charging and discharging of the first ignition coil and the second ignition coil whenever the number of the engine cycle exceeds a predetermined number of times.

The ignition controller may change a sequence of charging and discharging of the first ignition coil and the second ignition coil for every engine cycle.

An ignition coil control method according to another exemplary embodiment of the present disclosure that controls discharge currents of a first ignition coil and a second ignition coil for generating spark discharge between a center electrode and a ground electrode of a spark plug, may include, receiving, by an ignition controller, a pulse signal from an engine control unit, determining, by the ignition controller, a number of an engine cycle exceeds a predetermined number of times, and selectively executing, by the ignition controller, a first mode and a second mode whenever the number of the engine cycle exceeds a predetermined number of times or for every engine cycle, wherein charging and discharging of the first ignition coil are performed before the second ignition coil in the first mode, and charging and discharging of the second ignition coil are performed before the first ignition coil in the second mode.

According to an exemplary embodiment of the present disclosure, charging and discharging sequence of two ignition coils are changed according to an engine cycle, thereby improving durability of the ignition coils.

### BRIEF DESCRIPTION OF THE FIGURES

These drawings are for reference only in describing exemplary embodiments of the present disclosure, and therefore, the technical idea of the present disclosure should not be limited to the accompanying drawings.

FIG. 1 illustrates a cross-sectional view of an engine in which a spark plug is mounted according to an embodiment of the present disclosure.

FIG. 2 illustrates a schematic view of an ignition coil control system according to an embodiment of the present disclosure.

FIG. 3 illustrates flowchart of an ignition coil control method according to an embodiment of the present disclosure.

FIG. 4 and FIG. 5 illustrate flowcharts of an ignition coil control method in a first mode according to an exemplary embodiment of the present disclosure.

FIG. 6 illustrates an operation of two ignition coils in a first mode according to an exemplary embodiment of the present disclosure.

FIG. 7 and FIG. 8 illustrate flowcharts of an ignition coil control method in a second mode according to an exemplary embodiment of the present disclosure.

FIG. 9 illustrates an operation of two ignition coils in a second mode according to an exemplary embodiment of the present disclosure.

### DETAILED DESCRIPTION

The present disclosure will be described more fully hereinafter with reference to the accompanying drawings, in which exemplary embodiments of the disclosure are shown. As those skilled in the art would realize, the described embodiments may be modified in various different ways, all without departing from the spirit or scope of the present disclosure.

In order to clearly describe the present disclosure, parts that are irrelevant to the description are omitted, and identical or similar constituent elements throughout the specification are denoted by the same reference numerals.

In addition, since the size and thickness of each configuration shown in the drawings are arbitrarily shown for convenience of description, the present disclosure is not necessarily limited to configurations illustrated in the drawings, and in order to clearly illustrate several parts and areas, enlarged thicknesses are shown.

Hereinafter, a spark plug applied to a control system of an ignition coil according to an embodiment of the present disclosure will be described in detail with reference to the accompanying drawings.

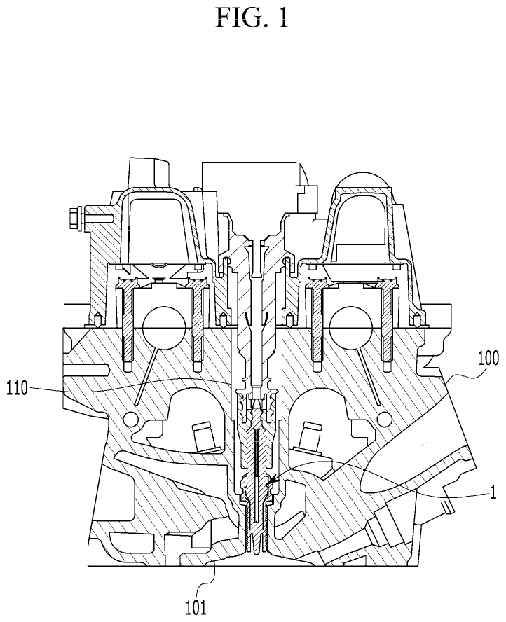

FIG. 1 illustrates a cross-sectional view of an engine in which a spark plug is mounted according to an embodiment of the present disclosure.

As shown in FIG. 1, a spark plug 1 according to an embodiment of the present disclosure is mounted on a cylinder of an engine, and generates spark discharge.

The engine to which the spark plug 1 is applied includes a cylinder block and a cylinder head 100, and the cylinder block and the cylinder head 100 are combined to form a combustion chamber 101 therein. An air and fuel mixture inflowing into the combustion chamber 101 is ignited by spark discharge generated by the spark plug 1.

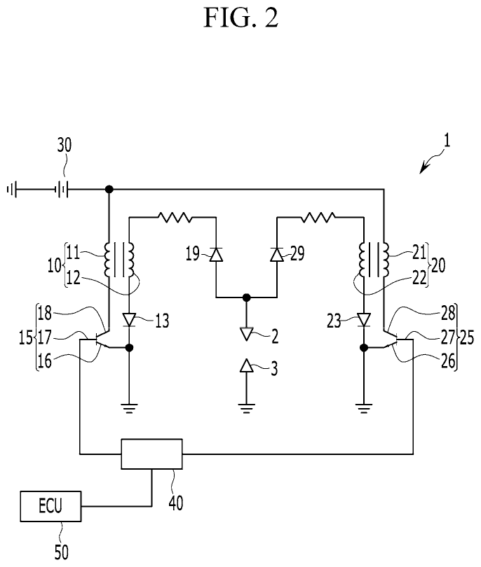

In the cylinder head 100, a mount hole 110 in which the spark plug 1 is mounted is vertically formed. A lower portion of the spark plug 1 that is mounted in the mount hole 110 protrudes into the combustion chamber 101. A center electrode 2 and a ground electrode 3 (shown in FIG. 2) that are electrically connected to an ignition coil are formed at the lower portion of the spark plug 1, and the spark discharge is generated between the center electrode 2 and the ground electrode 3.

FIG. 2 illustrates a schematic view of an ignition coil control system according to an embodiment of the present disclosure.

As shown in FIG. 2, an ignition coil control system according to an embodiment of the present disclosure may include an ignition controller 40 that adjusts amounts and durations of discharge currents of two ignition coils (e.g., a first ignition coil 10 and a second ignition coil 20) based on a pulse signal transmitted from an engine control unit 50 that controls an overall operation of an engine to control spark discharge generated at the electrodes. The ignition controller 40 may control ignition timing through the first ignition coil 10 and the second ignition coil 20 for every period of an engine cycle.

The first ignition coil 10 includes a primary coil 11 and a secondary coil 12, one end of the primary coil 11 is electrically connected to a battery 30 of a vehicle, and the other end of the primary coil 11 is grounded through a first switch 15.

According to an on/off operation of the first switch 15, the primary coil 11 of the first ignition coil 10 may be selectively electrically connected.

The first switch 15 may be realized with a NPN type transistor switch including an emitter terminal 16, a collector terminal 18, and a base terminal 17. That is, the other end of the primary coil 11 may be electrically connected to the collector terminal 18 of the first switch 15, the emitter terminal 16 thereof may be grounded, and the base terminal 17 thereof may be electrically connected to the ignition controller 40.

One end of the secondary coil 12 is electrically connected to the center electrode 2, and the other end thereof is electrically connected to the emitter terminal 16 of the first switch 15. A diode 13 is positioned between the secondary coil 12 and the emitter terminal 16 to block a current from flowing from the secondary coil 12 to the emitter terminal 16.

In addition, a diode 19 is positioned between the secondary coil 12 and the center electrode 2, so that a current flows only from the secondary coil 12 to the center electrode 2.

When a control signal is applied to the base terminal 17 of the first switch 15 by the ignition controller 40, the primary coil 11 of the first ignition coil 10 is electrically connected, and electrical energy is charged to the primary coil 11. When no control signal is applied to the base terminal 17 of the first switch 15 by the ignition controller 40, a high voltage current (or discharge current) is generated in the secondary coil 12 due to electromagnetic induction of the primary coil 11 and the secondary coil 12. The discharge current generated in the secondary coil 12 flows to the center electrode 2, and while spark discharge being generated between the center electrode 2 and the ground electrode 3 by the discharge current generated in the secondary coil 12, an air-fuel mixture inside the combustion chamber 101 is ignited.

That is, the ignition controller 40 charges or discharges the first ignition coil 10 by turning on/off the first switch 15. When the ignition controller 40 applies a control signal to the base terminal 17 of the first switch 15 (or when the switch is turned on), the primary side coil 11 is charged (or the first ignition coil is charged).

In addition, when the ignition controller 40 does not apply a control signal to the base terminal 17 of the first switch 15 (or when the first switch is turned off), a high voltage current is generated in the secondary coil 12 due to electromagnetic induction with the primary coil 11, and spark discharge is generated between the center electrode 2 and the ground electrode 3 (or the first ignition coil is discharged) by the high voltage current generated in the secondary coil 12.

Like the first ignition coil 10, the second ignition coil 20 includes a primary coil 21 and a secondary coil 22, one end of the primary coil 21 is electrically connected to the battery 30 of the vehicle, and the other end of the primary coil 21 is grounded through a second switch 25. According to an on/off operation of the second switch 25, the primary coil 21 of the second ignition coil 20 may be selectively electrically connected.

The second switch 25 may be realized with a NPN type transistor switch including an emitter terminal 26, a collector terminal 28, and a base terminal 27. That is, the other end of the primary coil 21 may be electrically connected to the collector terminal 28 of the second switch 25, the emitter terminal 26 thereof may be grounded, and the base terminal 27 thereof may be electrically connected to the ignition controller 40.

One end of the secondary coil 22 is electrically connected to the center electrode 2, and the other end thereof is electrically connected to the emitter terminal 26 of the second switch 25. A diode 23 is installed between the secondary coil 22 and the emitter terminal 26 to block a current from flowing from the secondary coil 22 to the emitter terminal 26.

In addition, the diode 23 is installed between the secondary coil 22 and the center electrode 2, so that a current flows only from the secondary coil 22 to the center electrode 2.

When a control signal is applied to the base terminal 27 of the second switch 25 by the ignition controller 40, the primary coil 21 of the second ignition coil 20 is electrically connected, and electrical energy is charged to the primary coil 21. When no control signal is applied to the base terminal 27 of the second switch 25 by the ignition controller 40, a high voltage current (or discharge current) is generated in the secondary coil 22 due to electromagnetic induction of the primary coil 21 and the secondary coil 22. The discharge current generated in the secondary coil 22 flows to the center electrode 2, and while spark discharge being generated between the center electrode 2 and the ground electrode 3 by the discharge current generated in the secondary coil 22, an air-fuel mixture inside the combustion chamber 101 is ignited.

That is, the ignition controller 40 charges or discharges the second ignition coil 20 by turning the second switch 25 on/off. When the ignition controller 40 applies a control signal to the base terminal 27 of the second switch 25 (or when the switch is turned on), the primary side coil 21 is charged (or the second ignition coil is charged).

In addition, when the ignition controller 40 does not apply a control signal to the base terminal 27 of the second switch 25 (or when the second switch is turned off), a high voltage current is generated in the secondary coil 22 due to electromagnetic induction with the primary coil 21, and spark discharge is generated between the center electrode 2 and the ground electrode 3 (or the second ignition coil is discharged) by the high voltage current generated in the secondary coil 22.

In the specification of the present disclosure, charging the primary coil of the first ignition coil 10 by turning on the first switch 15 is described as charging the first ignition coil 10, and a high voltage current is induced to the secondary coil of the first ignition coil 10 by turning off the first switch 15 and thus spark discharge occurs between the center electrode 2 and the ground electrode 3 is described as the first ignition coil 10 being discharged.

Likewise, charging the primary coil of the second ignition coil 20 by turning on the second switch 25 is described as charging the second ignition coil 20, and a high voltage current is induced to the secondary coil of the second ignition coil 20 by turning off the second switch 25 and thus spark discharge occurs between the center electrode 2 and the ground electrode 3 is described as the second ignition coil 20 being discharged.

The ignition coil control system according to the embodiment of the present disclosure controls the charging and discharging of the two ignition coils based on the pulse signal transmitted from the engine control unit 50, so that it is possible to accurately control the ignition timing of the spark discharge generated between the center electrode 2 and the ground electrode 3, and improve durability of the ignition coils 10 and 20.

To this end, the ignition controller 40 may be provided as at least one processor executed by a predetermined program, and the predetermined program is configured to perform respective steps of a control method of the spark plug 1 according to an embodiment of the present disclosure.

Hereinafter, the operation of the ignition coil control system according to the embodiment of the present disclosure as described above will be described in detail with reference to the accompanying drawings.

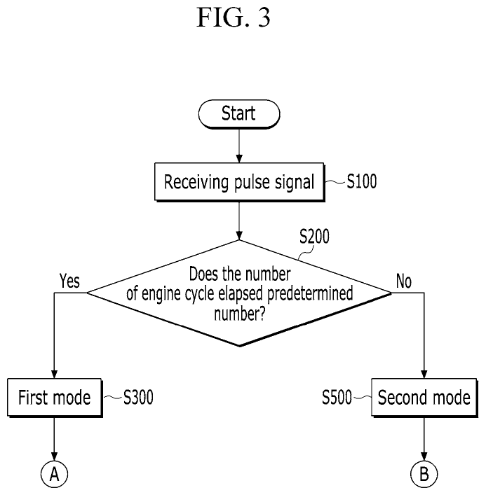

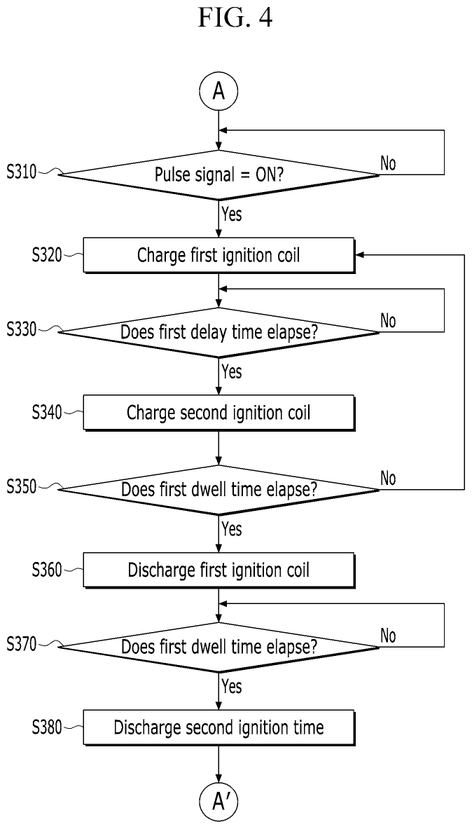

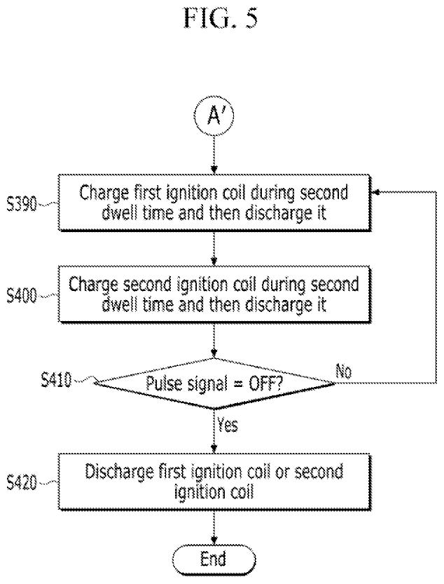

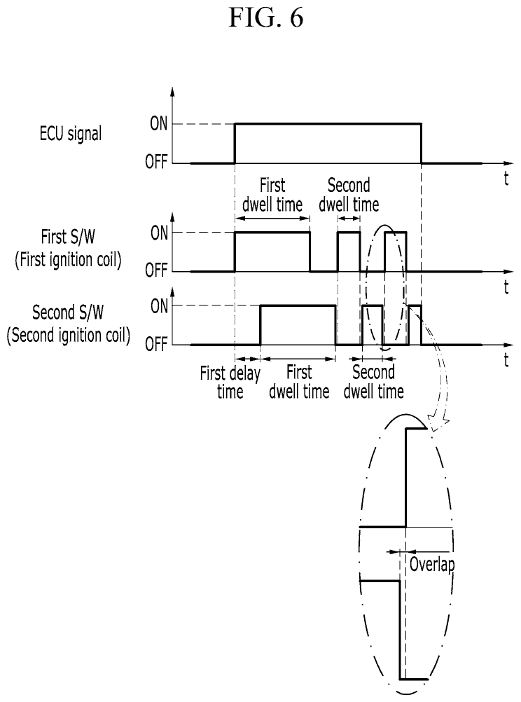

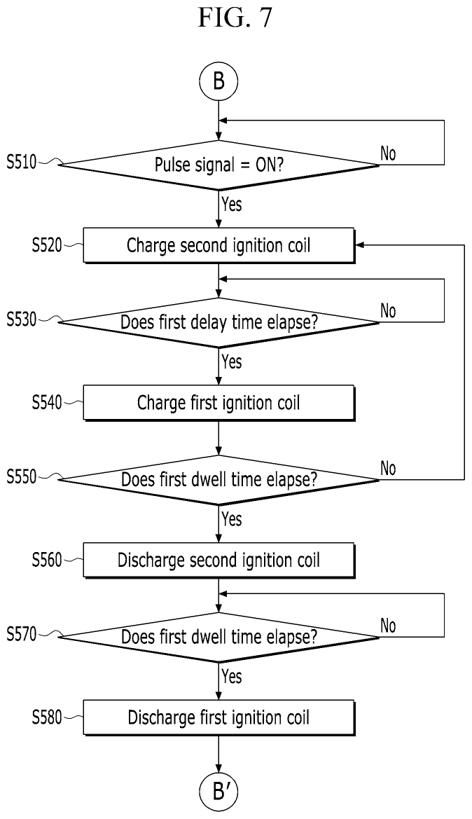

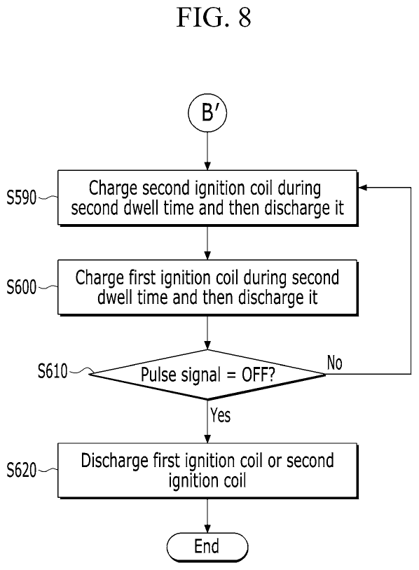

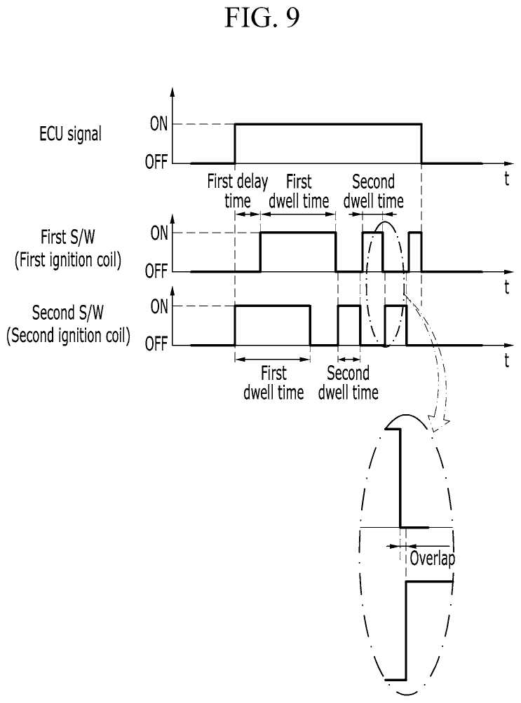

FIG. 3 illustrates flowchart of an ignition coil control method according to an embodiment of the present disclosure. FIG. 4 and FIG. 5 illustrate flowcharts of an ignition coil control method in a first mode according to an exemplary embodiment of the present disclosure. FIG. 6 illustrates an operation of two ignition coils in a first mode according to an exemplary embodiment of the present disclosure. FIG. 7 and FIG. 8 illustrate flowcharts of an ignition coil control method in a second mode according to an exemplary embodiment of the present disclosure. FIG. 9 illustrates an operation of two ignition coils in a second mode according to an exemplary embodiment of the present disclosure.

As shown in FIG. 3, the engine control unit (ECU) 50 transmits a pulse signal (or ECU signal) to the ignition controller 40 to ignite the air-fuel mixture inflowing into the combustion chamber 101 during an explosion stroke of the engine at S100. That is, the ignition controller 40 receives the pulse signal from the engine control unit 50.

In a case of 4-stroke engine, an engine cycle includes an intake stroke, a compression stroke, an explosion stroke and an exhaust stroke.

The pulse signal transmitted from the engine control unit 50 may include a single pulse signal having constant voltage and a dual pulse single comprising a first pulse signal and a second pulse signal having constant voltage.

The ignition controller 40 controls the number of the engine cycle, when the number of the engine cycle is odd numbered (or, the number of the engine cycle exceeds a predetermined number of times) at S200, the ignition controller 40 controls the ignition coil in a first mode at S300. In order words, the ignition controller 40 selectively executes a first mode and a second mode whenever the number of the engine cycle exceeds a predetermined number of times or for every engine cycle.

In the first mode, charging and discharging of the first ignition coil 10 are performed before the second ignition coil 20.

Referring to FIG. 4 to FIG. 6, when the number of the engine cycle is odd numbered (2N+1th), the ignition controller 40 charges the first ignition coil 10 and then discharges the first ignition coil 10 in synchronization with the pulse signal the pulse signal is transmitted from the engine control unit 50. That is, when the pulse signal is on at S310, the ignition controller 40 turns on the first switch 15 to charge the first ignition coil 10 at S320.

When a predetermined delay time elapses from on time point of the pulse signal at S330, the ignition controller 40 turns on the second switch 25 to charge the second ignition coil 20 at S340.

When a predetermined first dwell time elapses from on time point of the pulse signal at S350, the ignition controller 40 turns off the first switch 15 to discharge the first ignition coil 10 at S360. Here, the first dwell time may be a time during which the first ignition coil 10 and the second ignition coil 10 are fully charged. In this case, the time during which the first ignition coil 10 and the second ignition coil 20 are fully charged may be changed according to the output voltage of the battery 30. For example, when the output voltage of the battery 30 is high, the first dwell time may be shortened, and when the output voltage of the battery 30 is low, the first dwell time may be lengthened.

When the first dwell time elapses from the charging time point of the second ignition coil 20 at S370, the ignition controller 40 turns off the second switch 25 to discharge the second ignition coil 20 at S380.

After the second ignition coil 20 is discharged, the ignition controller 40 charges the first ignition coil 10 by turning on the first switch 15 during the second dwell time, and then discharges the first ignition coil 10 at S390. Here, the second dwell time may be set to be shorter than the first dwell time.

After the first ignition coil 10 is discharged, the ignition controller 40 charges the second ignition coil 20 by turning on the second switch 25 during the second dwell time, and then discharges the second ignition coil 20 at S400.

In this case, after the first ignition coil 10 is initially discharged, the ignition controller 40 adjusts the charging timing and discharging timing of the first ignition coil 10, and the charging timing and discharging timing of the second ignition coil 20, so that a charging period of the first ignition coil 10 and a charging period of the second ignition coil 20 do not overlap. In other words, after the first ignition coil 10 is initially discharged, the discharging period of the first ignition coil 10 and the discharging period of the second ignition coil 20 may overlap.

As described above, when the discharging period of the first ignition coil 10 and the discharging period of the second ignition coil 20 overlap, the spark discharge is continuously generated between the center electrode 2 and the ground electrode 3, and ignition energy may be efficiently transmitted to the air-fuel mixture in the combustion chamber 101. Therefore, the discharge efficiency of the spark plug 1 may be improved.

When the pulse signal is off at S410, the ignition controller 40 discharges the first ignition coil 10 or the second ignition coil 20 at S420. For example, when the pulse signal is off while the first ignition coil 10 is being charged, the ignition controller 40 discharges the first ignition coil 10 when the pulse signal is off. In addition, when the pulse signal is off while the second ignition coil 20 is being charged, the ignition controller 40 discharges the second ignition coil 20 when the pulse signal is off.

Referring back to FIG. 3, when the number of the engine cycle is even numbered at the step S200, the ignition controller 40 controls the ignition coils in a second mode at S500. In the second mode, the second ignition coil 20 is charged and discharged before the first ignition coil 10.

Referring to FIG. 7 to FIG. 9, when the number of the engine cycle is even numbered (2Nth), the ignition controller 40 charges the second ignition coil 20 and then discharges the second ignition coil 20 in synchronization with the pulse signal the pulse signal is transmitted from the engine control unit 50. That is, when the pulse signal is on at S510, the ignition controller 40 turns on the second switch 15 to charge the second ignition coil 10 at S520.

When a predetermined delay time elapses from on time point of the pulse signal at S530, the ignition controller 40 turns on the first switch 15 to charge the first ignition coil 10 at S540.

When a predetermined first dwell time elapses from on time point of the pulse signal at S550, the ignition controller 40 turns off the second switch 25 to discharge the second ignition coil 20 at S560.

When the first dwell time elapses from the charging time point of the first ignition coil 10 at S570, the ignition controller 40 turns off the first switch 15 to discharge the first ignition coil 10 at S580.

After the first ignition coil 10 is discharged, the ignition controller 40 charges the second ignition coil 20 by turning on the second switch 25 during the second dwell time, and then discharges the second ignition coil 20 at S390.

After the second ignition coil 20 is discharged, the ignition controller 40 charges the first ignition coil 10 by turning on the first switch 15 during the second dwell time, and then discharges the first ignition coil 10 at S600.

When the pulse signal is off at S410, the ignition controller 40 discharges the first ignition coil 10 or the second ignition coil 20 at S620. For example, when the pulse signal is off while the first ignition coil 10 is being charged, the ignition controller 40 discharges the first ignition coil 10 when the pulse signal is off. In addition, when the pulse signal is off while the second ignition coil 20 is being charged, the ignition controller 40 discharges the second ignition coil 20 when the pulse signal is off.

As described above, according to an exemplary embodiment of the present disclosure, a charging and a discharging sequence of the ignition coils 10 and 20 for generating spark discharge of the spark plug 1 is changed for every engine cycle or a predetermined number of the engine cycle.

That is, when the number of the engine cycle is odd numbered (2N+1th), the first ignition coil 10 is firstly charged and discharged to generate spark discharge before the second ignition coil 20. And when the number of the engine cycle is even numbered (2Nth), the second ignition coil 10 is firstly charged and discharged to generate spark discharge before the first ignition coil 10.

As described above, by changing the sequence of charging and discharging of the first ignition coil 10 and the second ignition coil 20 for every engine cycle, the equivalent load is applied to the two ignition coils 10 and 20, thereby improving durability of the two ignition coils 10 and 20.

If the number of charging and discharging of one of the two ignition coils 10 and 20 is greater than the number of charging and discharging of the other ignition coil, the temperature of the ignition coil that executes a lot of charging and discharging is excessively increased, and durability of the ignition coil is deteriorated.

However, according to an exemplary embodiment of the present disclosure, since the sequence of charging and discharging of the ignition coils 10 and 20 for generating spark discharge, the number of charging and discharging of the two ignition coils 10 may be kept almost the same. Through this, the durability of the two ignition coils 10 and 20 may be improved.

In the above description, changing the sequence of charging and discharging of the two ignition coils for every engine cycle has been described as an example.

However, the scope of the present disclosure is not limited thereto, the charging and discharging sequence of the ignition coils 10 and 20 may be changed wherever the predetermined number of the engine cycles elapsed. For example, the first ignition coil 10 may be firstly charged and discharged before the second ignition coil 20 for 10 engine cycles, and then the second ignition coil 20 may be firstly charged and discharged before the first ignition coil 10 for 10 engine cycles.

While this disclosure has been described in connection with what is presently considered to be practical exemplary embodiments, it is to be understood that the disclosure is not limited to the disclosed embodiments. On the contrary, it is intended to cover various modifications and equivalent arrangements included within the spirit and scope of the appended claims.

1. An ignition coil control system comprising:
a first ignition coil;
a second ignition coil:
a spark plug generating spark discharge by a discharge current generated in the first ignition coil and the second ignition coil; and
an ignition controller configured to control spark discharge of the spark plug by adjusting an amount and duration of the discharge current of the first ignition coil and the second ignition coil, and to change a sequence of charging and discharging of the first ignition coil and the second ignition coil based on a pulse signal transmitted from an engine control unit (ECU).

2. The ignition coil control system of claim 1, wherein the ignition controller changes a sequence of charging and discharging of the first ignition coil and the second ignition coil whenever the number of the engine cycle exceeds a predetermined number of times.

3. The ignition coil control system of claim 2, wherein the ignition controller changes a sequence of charging and discharging of the first ignition coil and the second ignition coil for every engine cycle.

4. An ignition coil control method that controls discharge currents of a first ignition coil and a second ignition coil for generating spark discharge between a center electrode and a ground electrode of a spark plug, the method comprising:
receiving, by an ignition controller, a pulse signal from an engine control unit;
determining, by the ignition controller, that a number of an engine cycle exceeds a predetermined number of times; and
selectively executing, by the ignition controller, a first mode and a second mode whenever the number of the engine cycle exceeds a predetermined number of times or for every engine cycle;
wherein charging and discharging of the first ignition coil are performed before the second ignition coil in the first mode, and charging and discharging of the second ignition coil are performed before the first ignition coil in the second mode.
